(19) United States
(12) Patent Application Publication
(10) Pub. No.: US 2007/0166142 A1
(43) Pub. Date: Jul. 19, 2007

(54) PLATFORM FOR FORKLIFT

(76) Inventors: JACQUES SENTENNE, Repentigny (CA); Denis Martel, Laval (CA); Denis Lemieux, Beloeil (CA)

Correspondence Address: GOUDREAU GAGE DUBUC, 2000 MCGILL COLLEGE, SUITE 2200, MONTREAL, QC, H3A 3H3, CA

(21) Appl. No.: 11/460,683

(22) Filed: Jul. 28, 2006

(30) Foreign Application Priority Data
Aug. 2, 2005 (CA) 2,514,362

(51) Int. Cl. B66F 9/18

(52) U.S. Cl. 414/619

(57) ABSTRACT

A working and cargo transporting platform, for use with a forklift, having a means for laterally reducing the distance between the platform and a shelf. The stability of the platform is improved by taking support on the shelf. When the forklift is in a narrow aisle the means for reducing distance can take support on both sides of the aisle thus stabilizing the platform. The means for reducing the distance may be affixed or included into the platform for laterally horizontally extending from the sides of the platform. A gap-filing extension allows the operator to move between the forklift, the platform and the shelves without stepping over an empty space. Sensors are installed on the platform to provide signal to the forklift about the position of the stabilizing and gap-filing moving parts.

### CROSS-REFERENCE TO RELATED APPLICATION

This application is related to and claims the benefit of priority to Canadian Patent Application No. 2,514,362, titled “PLATFORM FOR FORKLIFT”, filed on Aug. 2, 2005. The disclosure of this related application is specifically incorporated herein by reference.

### FIELD OF THE INVENTION

This invention relates to moveable platforms of the type commonly supported by a forklift.

### BACKGROUND OF THE INVENTION

In locations where there is high shelving, such as storage warehouses, objects to be positioned on shelves, or to be removed therefrom, are often handled by forklifts. Warehouses typically include a series of parallel rows of shelving, which are spaced by aisles, via which the forklifts can access the various shelves.

As well known in the art, forklifts are motorized machines for hoisting heavy objects (e.g. as boxes, bales, metal bars or other cargo loads) by means of horizontal forks that are inserted under the cargo load to be lifted or lowered, and that are displaced along guides or rails to the desired level via a motorized device. The motorized device is most of the time the hydraulic unit of the forklift itself. For instance typical forklifts, “orderpickers”, “motorized hand” and “electric rider” can be seen on the following websites http://www.toyotaforklift.com/products/toyota_lift_trucks/productline/op_{—}3000_{—}7bpue. aspx; http://nissanforklift.com/; and http://www.mit-lift.com/prodcat_{—}5.cfm.

Platforms for receiving the cargo loads to be carried by the forklift can be mounted to the forks or can completely replace the forks. Once attached to the forklift, the platform is moved vertically by the forklift to the required elevation in respect to the shelf for loading or unloading cargo loads onto the shelf. Rows and aisles are normally designed to be wide enough to let a forklift passes while not leaving much room on each side of a forklift so as to maximize space inside the warehouse. Cargo loads can therefore be moved from the platform to the shelf next to it. Various such platforms can be seen on the following website: http://www.superioreng.com/products_workplatforms.jsp.

When a cargo load is desired to be stored on a shelf, or to be removed therefrom, the forklift is operated so as to bring its forks, or platform, to the appropriate elevation next to the concerned shelf. On forklifts having the cabin moving with the cargo load the operator then disembarks from his position in the forklift's cabin and reaches the platform so as to move the load from the platform onto the shelf, or vice versa. Moving loads on the platform can provoke oscillation of the platform or enlarge the gap between the platform and the opposed shelf. Oscillations of the platform or an increased distance created between the platform and the shelf may put the operator into undesirable conditions. The operator may loose his balance and slip on an oscillating platform or loose support by putting a foot in the empty space between the platform and the shelf.

Therefore, there exists a need in the art for an improved standing platform for a forklift. There is a need in the art for such a more stable platform. And, there is a need in the art for such a platform which can be installed easily on a forklift.

### SUMMARY OF THE INVENTION

It is one aspect of the present invention to alleviate one or more of the drawbacks of the background art by addressing one or more of the existing needs in the art.

Accordingly, one aspect of one or more embodiments of this invention provides a standing platform on a forklift having a stabilization system.

Another aspect of one or more embodiments of the present invention provides a standing platform on a forklift having a stabilization mechanism that substantially precludes oscillation of the platform.

Another aspect of one or more embodiments of the present invention provides a standing platform for a forklift having a stabilization mechanism reducing the size of the gap between the standing platform and a shelf when the platform is abutted to a shelf for loading or unloading cargo loads.

Another aspect of one or more embodiments of the present invention provides a standing platform for a forklift having a mechanism substantially covering the gap between the standing platform and the shelf when the platform is abutted to a shelf.

Another aspect of one or more embodiments of the present invention provides a removable standing platform for a forklift having stabilization mechanisms or gap-filling mechanisms actuated by the operator of the forklift.

Another aspect of one or more embodiments of the present invention provides a forklift operator's cockpit having a gap-filling mechanism distinct from the platform. The gap-filling mechanism can be a kit that be temporarely added to an existing platform.

According to a further aspect of one or more of these embodiments, the stabilization mechanisms or gap-filing mechanisms are powered by the power unit of the forklift.

According to a further aspect of one or more of these embodiments, the stabilization mechanisms or gap-filing mechanisms are powered by a power unit distinct from the power unit of the forklift.

According to a further aspect of one or more of these embodiments, the stabilization mechanism uses a shelf-contacting element made of a non-metallic material.

According to a further aspect of one or more of these embodiments, a signal is sent to the forklift when the stabilization mechanism is active thus preventing the forklift from moving.

According to a further aspect of one or more of these embodiments, a visual indicator is activated when the stabilization mechanism is activated.

According to another aspect of one or more of these embodiments, the guard rail protecting the operator of the forklift can be opened only when the stabilization mechanism is activated.

Therefore, in accordance with an aspect of the present invention, there is provided a vehicle for moving cargo loads along a structure comprising a frame having a longitudinal axis; a power unit; a rail connected to the frame; a platform connected to the rail for vertically moving along with the cargo loads carried thereby; and at least one extendable mechanism affixed to the platform and moving relative to the platform for at least one of contacting the structure, for increased stability of the platform, and reducing a gap between the platform and the structure, when the platform is used in proximity of the structure.

In accordance with another aspect of the present invention is provides a platform for moving cargo loads, along a structure, when used in conjunction with a forklift, the forklift having: a frame, and the platform being vertically displaceable relative thereto; the platform comprising at least one extendable mechanism movable for at least one of contacting the structure, for increased stability of the platform, and reducing a gap between the platform and the structure, when the platform is used in proximity of the structure.

According to a further aspect of the present invention is provided a platform for moving cargo loads to and from a structure, when used in conjunction with a forklift, the forklift having: a frame, the platform being displaceable relative thereto, and a fork; the platform comprising a means for laterally enlarging the width of the platform when the platform is used in conjunction with the forklift.

According to another aspect of the present invention is provided a method for positioning a platform supported by a vehicle comprising the steps of: adjusting the position of the vehicle relative to a structure; adjusting the height of the platform relative to the vehicle; and moving at least one extendable mechanism relative to the platform to improve a stability of the platform when the platform is used in proximity of the structure.

Other aspects and further scope of applicability of the present invention will become apparent from the detailed description given hereinafter. However, it should be understood that the detailed description and specific examples, while indicating illustrative embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, discloses illustrative embodiments of the invention.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is a rear-right side perspective view of a forklift and a standing platform in the lower position thereof according to one embodiment of the present invention;

FIG. 2 is a right side elevation view of the forklift and standing platform in the lower position according to one embodiment of the present invention, with the operator safety rail being shown in closed and opened positions thereof respectively in full and broken lines;

FIG. 3 is a right-left-top perspective view of the standing platform;

FIG. 4 is a bottom perspective view of the standing platform;

FIG. 5 is a partial bottom perspective view of a lateral extendable member according to one embodiment of the present invention;

FIG. 6 is a partial bottom perspective view of a gap-filing extension unfolding and return mechanisms shown in a lowered collapsed position thereof, according to another embodiment of the present invention;

FIG. 7 is a partial bottom perspective view of the gap-filing extension unfolding mechanism shown in an upper extended position thereof;

FIG. 8 is a partial front elevation view (bubble A in FIG. 10) of the gap-filing extension unfolding mechanism being shown in the collapsed and extended positions respectively in broken and full lines with the gap-filing extension;

FIG. 9 is a partial front elevation view (bubble B in FIG. 10) of the extendable member extended shown in retracted and extended positions thereof respectively in broken and full lines;

FIG. 10 is a rear elevation view of a forklift between two series of shelves with the gap-filing and stabilization mechanisms of the standing platform thereof being activated;

FIG. 11A is a cross-sectional view of the gap filing extension taken along line A-A of FIG. 11B;

FIG. 11B is a top view of the gap filing extension; and

FIG. 11C is a cross-sectional view of the gap filing extension taken along line C-C of FIG. 11B.

### DETAILED DESCRIPTION OF THE ILLUSTRATIVE EMBODIMENTS

An illustrative embodiment of the present invention is described herein with reference to the drawings.

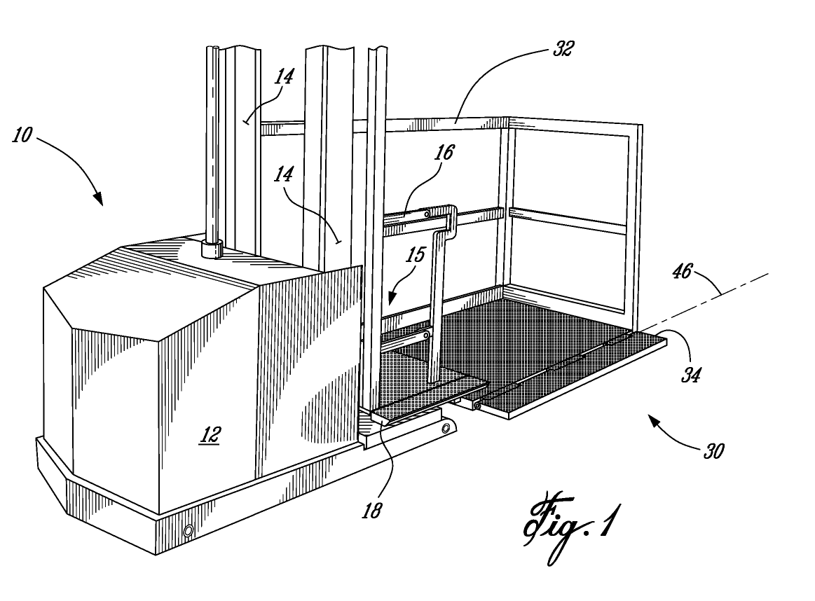

FIG. 1 illustrates a forklift 10 having a rear portion for accommodating a power unit 12. The forks (not visible in FIG. 1) are forwardly extending from a vertical rail 14 for supporting cargo loads. The forklift 10 has an operator cockpit 15 protected by a moveable rail protector 16. Rail protection is required since the operator cockpit 15 moves vertically with the forks allowing the operator to reach the shelves.

Still in FIG. 1, a platform 30 is engaged onto the forks for being lifted by the forklift 10. The forks support the platform in the embodiment illustrated in FIG. 1, however, other means for supporting a platform like hooks, fasteners, rods, magnets or actuators are encompassed by the present application. Platform 30 is used to carry cargo loads to a desired position where cargo loads can be placed onto the shelves. Operator cockpit 15 has a first gap-filing extension 18 moveable between a retracted and a extended position. The purpose of the first gap-filing extension 18 is to cover the gap between the operator cockpit 15 and the shelf to avoid the operator from falling into the gap. A second gap-filing extension 34 is provided on the platform 30 for the same reason and for allowing easier cargo transport from the platform to the shelf and vice versa. In the illustrated embodiment the second gap-filing extension 34 moves according to pivot axis 46. The operator cockpit gap-filing extension 18 can either be separate or connected to the platform gap-filing extension 34. As would be appreciated by those skilled in the art, other means for reducing or covering the distance between shelves and the platform 30 are also contemplated to fall within the scope of the invention.

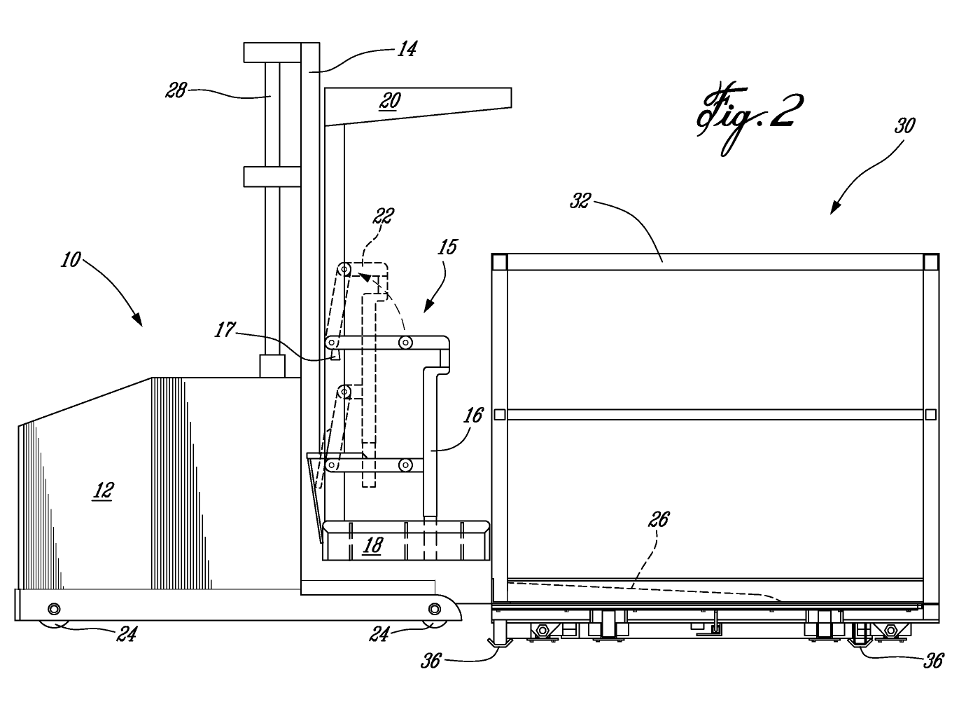

Referring to FIG. 2 it is possible to see different positions of a rail protector 16. Recessed, or open position 22 (shown in broken lines) allows the operator to exit the cockpit 15 without danger. A sensor 17 indicates to the forklift 10 in which position the rail protector 16 is. The sensor 17 influences the movements of the forklift 10 to ensure safety of the operator. The sensor 17 sends a signal interpreted by the control unit of the vehicle to prevent movement of the vehicle when the rail protector 16 is in an undesirable position for moving the forklift. The same principle is applied for sensing the position of the extendable members 38 and preclude movements of the forklift 10 according to predetermined conditions. The side view of the forklift 10 also depicts wheels 24 supporting the forklift 10, a protective top 20 over cockpit 15 and a platform safety rail 32. The platform 30 has several ground contacting supports 36 and a space for accommodating forks 26 such that the platform can be lifted by the forklift 10 using a hydraulic cylinder 28.

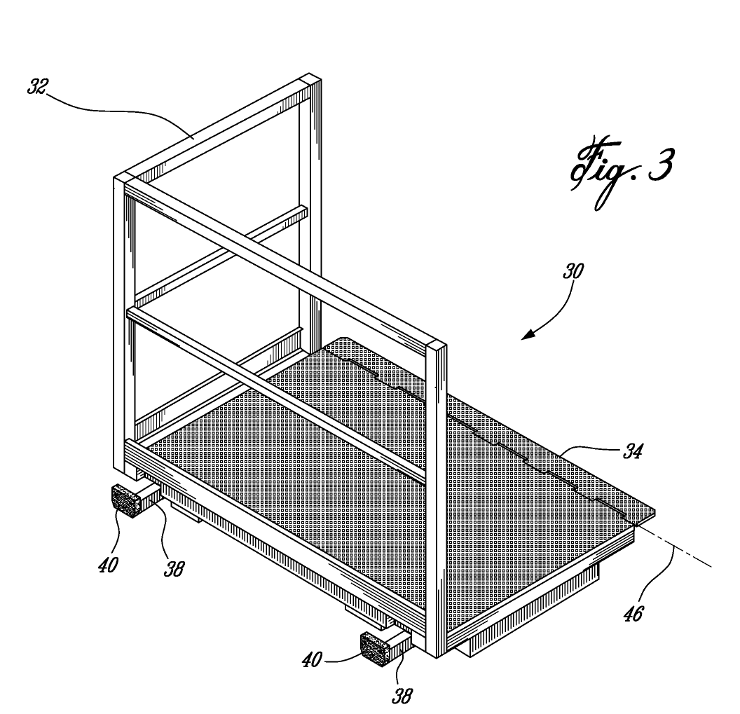

FIG. 3 depicts the platform 30 with lateral extendable members 38 (or extendable mechanism) thereof being disposed low on the left side. The extendable members 38 have contact pads 40 on extremities thereof to promote adequate lateral contact with the shelves. Contact pads 40 may be made of a non-conductive material to avoid risks of electricity transfer between the shelves and the platform 30. A polymeric material may be suitable to prevent damaging the shelves while providing a good contact. The second gap-filing extension 34 moves according to axis 46 and is presented on FIG. 3 in its upper extended position.

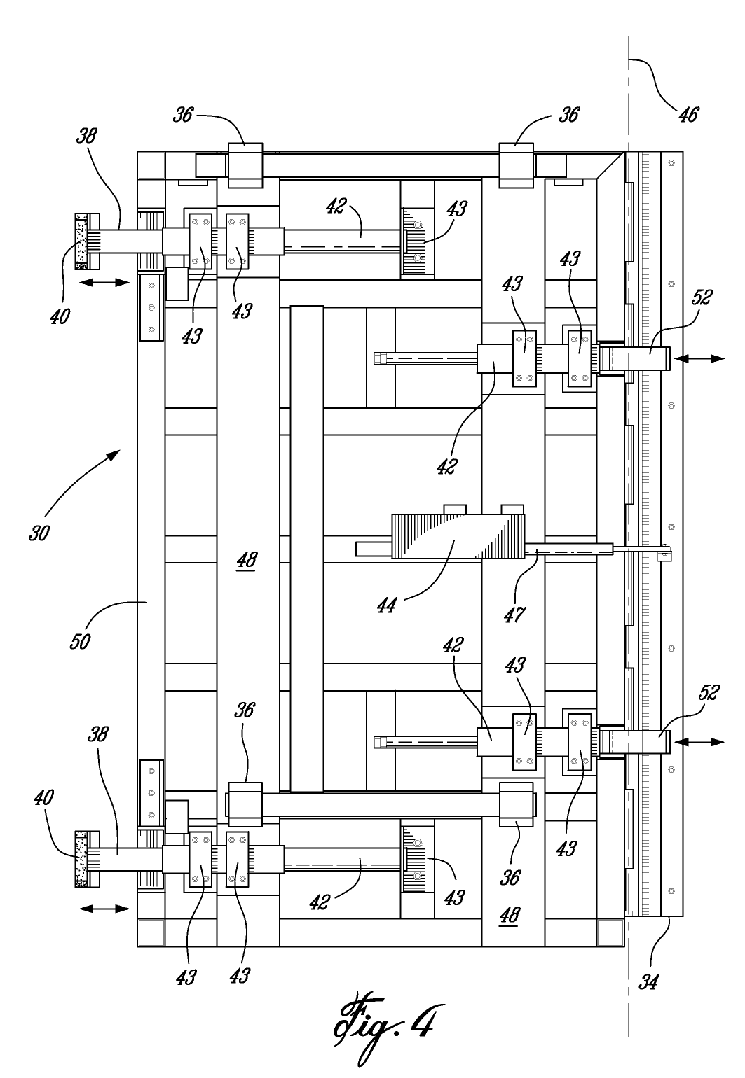

As best seen in the illustrative embodiment shown in FIG. 4, lateral extendable members 38 and 52 are affixed underneath the platform 30 to frame 50 or to fork receptacles 48. The extendable members 38 and 52 are maintained onto the platform 30 by supports 43. Lateral extendable members 38 are intended to contact the shelves and push (or simply maintain) the platform 30 or the second gap-filing extension 34 thereof abutted (or close) to the shelves on the opposite side. Similarly, lateral extendable members 52 are used to move the platform's gap-filing extension and could also be used to contact the shelves on the gap-filing extension 34 side to improve stability to the platform 30. Supports 43 maintain the extendable members 38 and 52 while allowing movement induced by actuators 42. In this embodiment, actuators 42 are axially disposed next to each lateral extendable member 38, 52. Extendable members are positioned are on the lateral sides and preferably close to the longitudinal extremity to maximize the platform stability.

A person skilled in the art of building forklift platforms would know electric actuators, pneumatic actuators, hydraulic actuators or any other kind of manual or assisted mechanisms capable of moving the extendable members could be used and are within the scope of the present patent specification. Hydraulic actuators may use the hydraulic system of the forklift 10 or an independent hydraulic pump to generate the power needed to move the actuators 42. Typical valves and circuitry would likely be used but would not be discussed further because they are considered well known in the art of hydraulic. The use of a pneumatic system or an electric system, using either the forklift power or and external power source, are also contemplated and within the scope of this invention.

A linkage 47 connects the second gap-filing extension 34 to gap-filing extension sensor 44. This way the position of the second gap-filing extension 34 can be considered by the forklift 10 to prevent undesirable movements when the second gap-filing extension 34 is in the extended position.

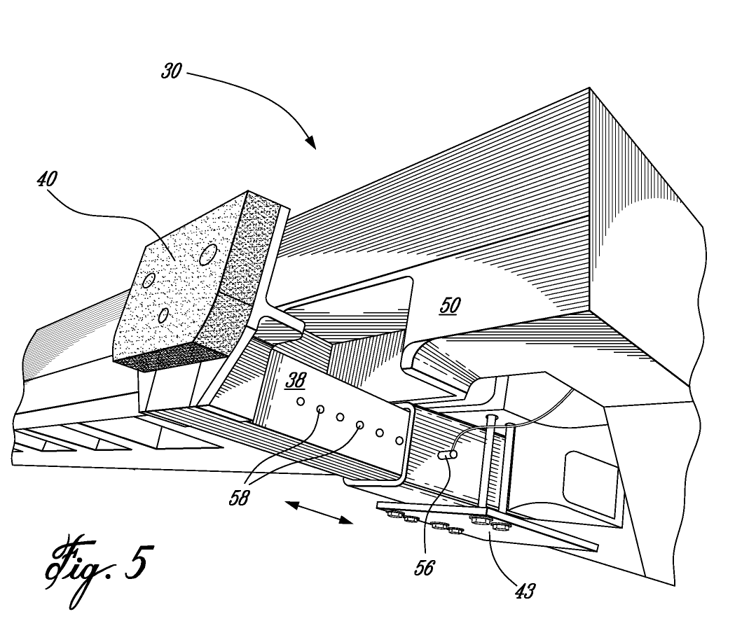

FIG. 5 is a closer view of the extendable member 38 and reading marks 58 thereof, with a sensor 56 affixed to frame 50. The sensor 56 sends a signal as to the position of the extendable member 38 to the forklift 10 to prevent undesirable movements when the extendable member 38 is in the extended position.

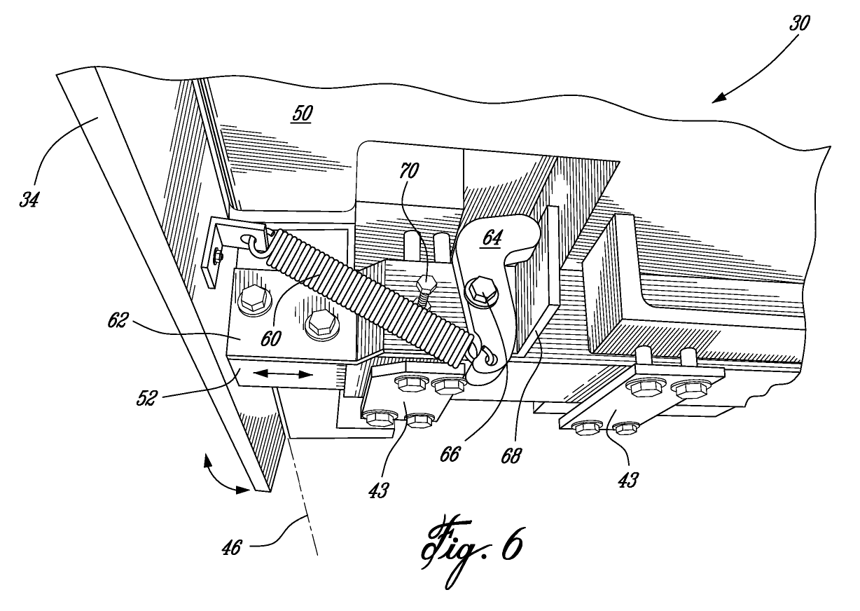

FIG. 6 depicts the second gap-filing extension 34 return mechanism. When extendable member 52 extends it pushes the second gap-filing extension 34 to its extended position. The return mechanism ensures that the second gap-filing extension 34 will come back to its retracted position at the same time as extendable member 52 retracts. A spring 60 is connected to extendable member 52 via a rocker 64 and a bracket 62. The spring 60 stretches when the second gap-filing extension 34 extends, and retracts when gap-filing extension 34 retracts. Rocker 64 changes the anchor point of spring 60 on bracket 62 by moving between stoppers 70 and 68 about pivot 66. Maximum tension is thus applied to spring 60 when extendable member 52 comes close to its fully retracted position when rocker 64 enters in contact with stopper 68 affixed to the frame of the platform 30.

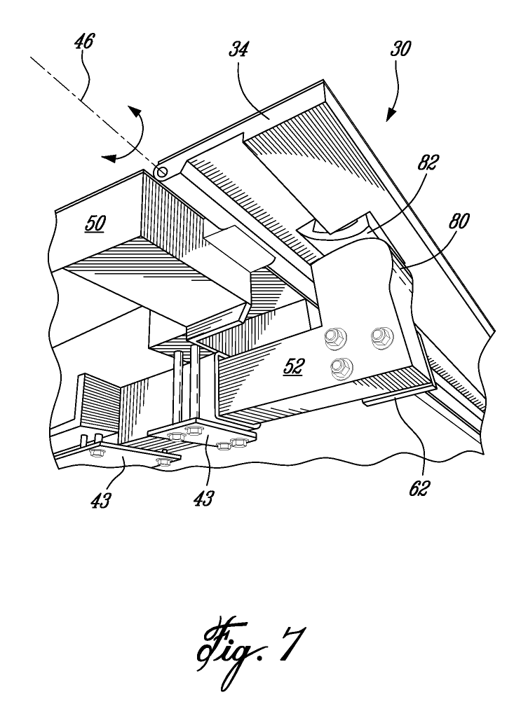

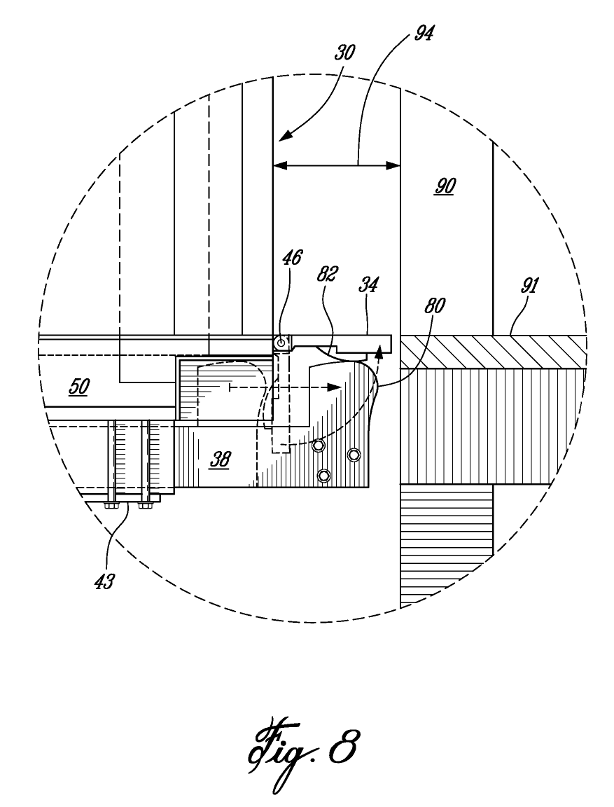

Extendable member 52, as seen on FIG. 7, has a round shaped portion 80 pushing curved ramp 82 of the second gap-filing extension 34. The two co-operating rounded shapes ensure a smooth and even movement of the second gap-filling extension 34. The same movement is depicted in FIG. 8 while showing the relationship between the extended second gap-filing extension 34 and the adjacent shelves 90.

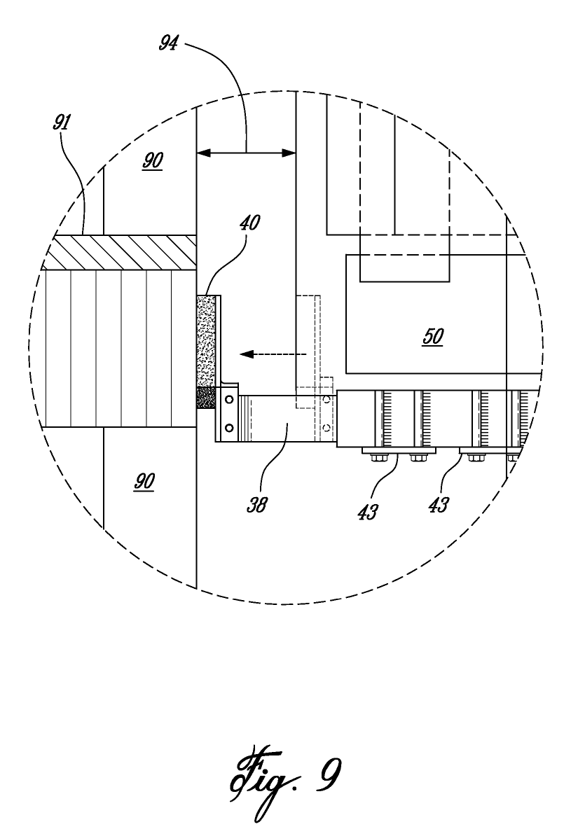

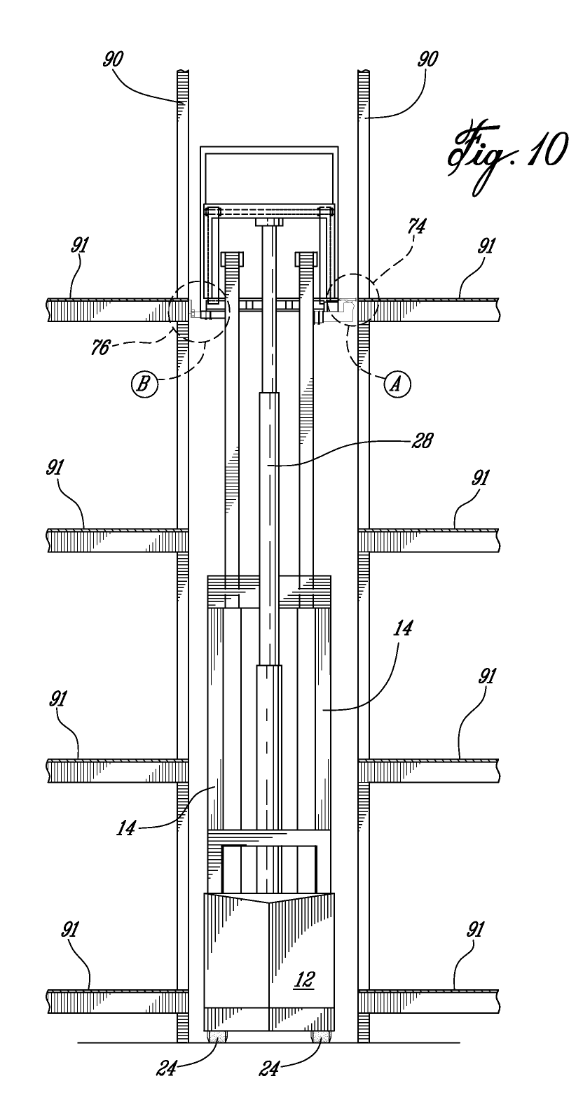

FIG. 9 shows the movement of extendable member 38 next to shelves 90 over gap 94. FIGS. 8 and 9 also indicate that the surface of the horizontal member 91 of the shelves 90 is at the same level as the platform's upper surface and second gap-filing extension 34. The environment of FIGS. 8 and 9 is shown on FIG. 10 as 74, 76, respectively, for better understanding.

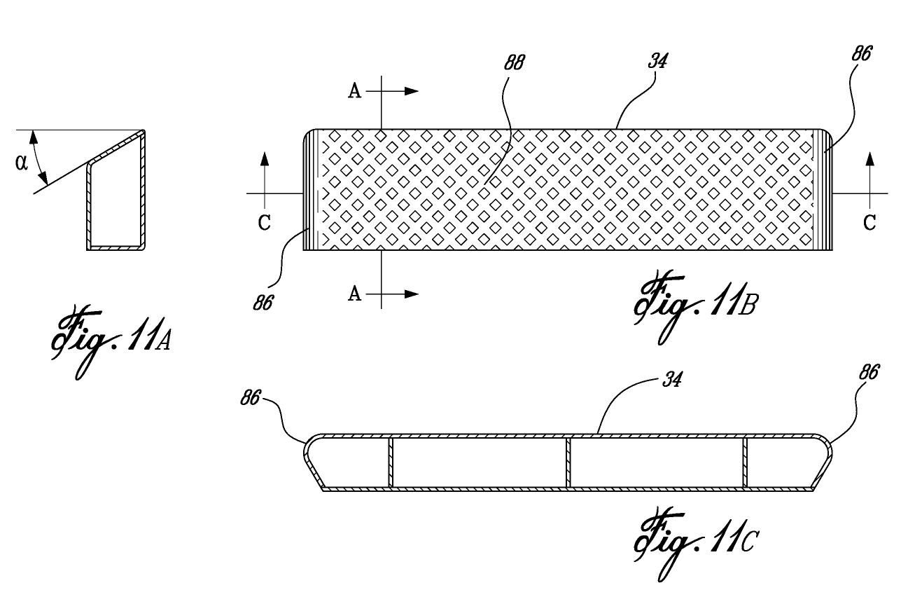

Finally, FIGS. 11A, 11B and 11C depict different views of the second gap-filing extension 34. The forward and rearward portions 86 of gap-filing extension 34 are rounded for preventing any sharp edges from injuring the operator. An angle α is defined on the side intended to extend next to the shelf to ensure the most even fit between the gap-filing extension upper surface 88 and the shelf horizontal member 91. All surfaces subject to support the operator are preferably covered of anti-slip material or made of a anti-slip textured metal sheet.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. A vehicle for moving cargo loads to and from a structure, the vehicle comprising:
a) a frame;
b) a power unit supported by the frame;
c) a rail connected to the frame and defining a path generally orthogonal to the ground;
d) a platform adapted to support cargo loads, the platform being connected to the rail and capable of movement along the path; and
e) at least one extendable mechanism affixed to the platform and moving relative to the platform for at least one of
i) contacting the structure, for increased stability of the platform, and
ii) reducing a gap between the platform and the structure, when the platform is used in proximity to the structure.

2. The vehicle claimed in claim 1, wherein the platform is configured to accommodate an operator.

3. The vehicle claimed in claim 1, wherein the extendable mechanism includes an extendable member adapted to contact the structure.

4. The vehicle claimed in claim 3, wherein the extendable member further includes a contacting pad at a free end thereof.

5. The vehicle claimed in claim 1, wherein the platform further defines a plane, the extendable mechanism extending parallel to the plane.

6. The vehicle claimed in claim 5, wherein the extendable mechanism includes a plurality of extendable members disposed on each side of the longitudinal axis.

7. The vehicle claimed in claim 1, further including a sensor for providing a signal based on a position of the extendable mechanism.

8. The vehicle claimed in claim 1, wherein the extendable mechanism includes a gap-filing extension having a retracted position and an extended position for bridging at least a portion of the gap between the platform and the structure when the platform is used in proximity to the structure.

9. The vehicle claimed in claim 8, wherein the gap-filing extension positions are dictated, at least in part, by the movement of at least one extendable member.

10. The vehicle claimed in claim 8, wherein the gap-filing extension influences a gap filing extension position sensor providing a signal based on the position of the gap-filing extension.

11. The vehicle claimed in claim 1, further including an operator safety railing, the safety railing adapted to displace between a first position precluding the passage of the operator of the platform and a second position allowing passage of the operator to the platform, the position of the safety railing influencing a movement of the vehicle to improve the stability of the platform.

12. A platform for moving cargo loads, to and from a structure, when used in conjunction with a forklift, the forklift having:
a) a frame;
b) a rail connected to the frame and defining a path generally orthogonal to the ground;
c) a platform support connected to the rail and adapted for moving along the path;
the platform comprising
d) at least one extendable mechanism movable for at least one of:
i) contacting the structure, for increased stability of the platform, and
ii) reducing a gap between the platform and the structure, when the platform is used in proximity of the structure.

13. The platform claimed in claim 12, wherein the platform is configured to accommodate an operator.

14. The platform claimed in claim 12, wherein the extendable mechanism includes an extendable member adapted to contact the structure.

15. The platform claimed in claim 14, wherein the extendable member further includes a contacting pad at a free end thereof.

16. The platform claimed in claim 12, wherein the platform further defines a plane, the extendable mechanism extending parallel to the plane.

17. The platform claimed in claim 16, wherein the extendable mechanism includes a plurality of extendable members disposed on each side of the longitudinal axis.

18. The platform claimed in claim 12, further including a sensor for providing a signal according to a position of the extendable mechanism.

19. The vehicle claimed in claim 12, wherein the extendable mechanism includes a gap-filing extension having a retracted position and an extended position for bridging at least a portion of the gap between the platform and the structure when the platform is used in proximity to the structure.

20. The vehicle claimed in claim 19, wherein the gap-filing extension positions are dictated, at least in part, by the movement of at least one extendable member.

21. The vehicle claimed in claim 19, wherein the gap-filing extension influences a gap filing extension position sensor providing a signal based on the position of the gap-filing extension.

22. The vehicle claimed in claim 12, further including an operator safety railing, the safety railing adapted to displace between a first position precluding the passage of the operator of the platform and an second position allowing passage of the operator to the platform, the position of the safety railing influencing a movement of the vehicle to improve the stability of the platform.

23. A platform for moving cargo loads to and from a structure when used in conjunction with a forklift, the forklift having:
a) a frame, the platform being displaceable relative thereto; and
b) a means for supporting the platform;
the platform comprising
c) a means for laterally enlarging the width of the platform when the platform is used in conjunction with the forklift.

24. The platform claimed in claim 23, wherein the means for laterally enlarging the width of the platform includes an extendable mechanism and a sensor, the sensor reacting to the position of the extendable mechanism and influencing a movement of the forklift when the platform is used in conjuntion with the forklift.

25. A method for positioning a platform supported by a vehicle comprising the steps of:
a) adjusting the position of the vehicle relative to a structure;
b) adjusting the height of the platform relative to the vehicle; and
c) moving at least one extendable mechanism, relative to the platform, to improve a stability of the platform when the platform is used in proximity of the structure.

26. The method claimed in claim 25, further comprising the steps of:
a) sensing the position of the at least one extendable mechanism; and
b) influencing a movement of the vehicle.
